(19) United States
(12) Patent Application Publication
(10) Pub. No.: US 2006/0050886 A1
(43) Pub. Date: Mar. 9, 2006

(54) Method and system for generating a common secret key

(75) Inventors: Pim Theo Tuyls, Eindhoven (NL); Marten Erik Van Dijk, Cambridge, MA (US); Berry Shoemakers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECRONICS N.V., EINDHOVEN (NL)

(21) Appl. No.: 10/528,487

(22) PCT Filed: Aug. 11, 2003
(86) PCT No.: PCT/IB03/03641

§ 371 Date: Mar. 18, 2005

(30) Foreign Application Priority Data
Sep. 20, 2002 (EP) 02078952.5

(51) Int. Cl. H04L 9/00

(52) U.S. Cl. 380/260

(57) ABSTRACT

A method for generating a common secret data item between a first user facility and a second user facility does so through by each facility executing mutually symmetric operations on respective complementary data items that are based on respectively unique quantities and that are at least in part secret. An outcome of the operations is used in both said user facilities as said common secret data item. In particular, the method is based on defining the complementary data belonging to a GAP Diffie-Hellmann Problem that is defined in an Abelian Variety. More in particular, the Abelian Variety has a dimension one through being an elliptic curve.

### BACKGROUND OF THE INVENTION

The invention relates to a method for generating a common secret data item between a first user facility and a second user facility through by each such user facility executing mutually symmetric operations on respective complementary data that are based on respectively unique quantities that are at least in part secret, and wherein an outcome of said operations is used in both said user facilities as said common secret data item as has been furthermore recited in the preamble of claim 1.

Shared key generation is an important issue in cryptography. The issue has spread to application fields such as Pay TV Systems in consumer electronics and various identification procedures. The secret data item may be used as an encryption or decryption key, for effecting mutual authentication among the user facilities, or other. Prior art has widely considered Diffie-Hellmann schemes, but these schemes disadvantageously lack a control mechanism for checking the authenticity of the calculated secret data item. Alternatively, a certificate based system allows to set up the shared secret data item has been proposed in U.S. Pat. No. 5,218,637, attorney docket PHQ 90.021 assigned to the present assignee, and among others by one of the coinventors of the present invention. This art solves the problem, but on the other hand requires a complex organization utilizing at least two levels of public key cryptography. A first object of the present invention is to use only a single integrated cryptography level. This implies that no second secret data item will be required to effect a verification operation.

A further object of the present invention is that the system should be extendable with extra user facilities offering the same level of secrecy as the existing system realized by the invention, but without requiring additional amendations to such existing system. Still another object of the present invention is that knowledge of the secret data items pertaining to an arbitrarily large subset of the user facilities should not allow a straightforward and feasible calculation of the respective secret data item for any further user facility present in the system. A further object of the present invention is to allow a compact representation of the various quantities and data items used.

### SUMMARY TO THE INVENTION

In consequence, amongst other things, it is an object of the present invention to provide an improved method for generating a common secret data item among two user facilies whilst meeting the above requirements.

Now therefore, according to one of its aspects the invention is characterized according to the characterizing part of claim 1. In particular, a first embodiment of the present invention bases on the usage of the so-called Weil Pairings that have been amply discussed in the explicit paper presented on CRYPTO 2001 by Dan Boneh & Matt Franklin, entitled “Identity Based Encryption from the Weil Pairing”. Furthermore, a second and even broader embodiment of the present invention bases on het usage of the so-called Abelian Varieties, and of which elliptic curves on which the Weil Pairings are effected constitute a sub-class. None of the above concepts have however been considered for the same manner of operating and objects as the present invention. Abelian varieties have been amply discussed in the explicit paper presented on CRYPTO 2002 by K. Rubin & A. Silverberg, entitled “Supersingular Abelian Varieties in Cryptology”. A further advantageous aspect of the present invention is that it will allow compact representations due to the straightforward mathematical procedures effectively used.

The invention also relates to a system comprising a first user facility and a second user facility, and being arranged to communicate according to the method as claimed in claim 1, to a device being arranged to operate as the first and/or second user facility in a system as claimed in claim 3, and to a computer program product comprising computer instructions for controlling one or more data processing oriented hardware entities to implement a method as claimed in claim 1. Further advantageous aspects of the invention are recited in dependent claims.

### BRIEF DESCRIPTION OF THE DRAWING

These and further aspects and advantages of the invention will be discussed more in detail hereinafter with reference to the disclosure of preferred embodiments, and in particular with reference to the appended Figures that show:

FIG. 1, a system comprising various devices that are interconnected via a network and are arranged to operate in accordance with the invention;

FIG. 2, a generalization of the system of FIG. 1.

### MATHEMATICAL SKETCH OF THE PROCEDURE USED

A basic embodiment of the present invention bases on the Weil pairing, which is a bilinear mapping from elliptic curves to finite fields. It is used to express the Discrete Log problem on finite fields in terms of compact representations on an elliptic curve. This procedure allows to use a shared secret data item and further parameters that can have bit lengths less than 200 bits, whilst still presenting codebreakers with computational complexities that compare with, or are larger than those of prior art systems to render such codebreaking effectively unfeasible. The proposed system is furthermore very robust in that knowledge of the data of a finite number of participants will not give away the system secret which otherwise would have allowed the generation of new shared keys with arbitrary compliant users.

Furthermore, every user or device has its own unique parameters, which allows to set up a revocation scheme on top of the standard scheme for excluding selected devices when such becomes necessary. As such, the system allows the generating of shared secret data items between any pair of users whilst requiring much less storage capacity than classical systems.

Now, the proposed protocol of the present embodiment bases on an extended version of the Diffie-Hellmann problem. Note that on an elliptic curve E, the Computational Diffie-Hellmann (CDH) problem looks as follows. Given a point P ε E and given aP and bP, there exists no algorithm that computes abP in polynomial time. Now, the present invention applies an extended Diffie-Hellmann problem or EDH which regarding the present invention is defined as follows:
P, aP, bP, a²P, b²P→abP

Admittedly, in the generic model this will still poses a difficult problem for calculating. Incidentally, the Decision Diffie-Hellmann or DDH problem on an elliptic curve is quite a bit more simple. The DDH problem is defined according to: when given three points aP, bP, cP, wherein P ε E, decide whether or not cP=(a*b)P. This relative simplicity follows from an efficiently computable bilinear mapping known as the Weil Pairing, which will be further discussed below; furthermore the referenced publications will offer additional information. In particular, such groups where the DDH is relatively simple but CDH is difficult are said to present a GAP Diffie-Hellmann group. Such groups are found in Abelian varieties, of which the supersingular elliptic curves are a subcategory with dimension 1 thereof. Now, of various feasible such elliptic curves where the computational Diffie-Hellmann problem is difficult but the DDH is much easier, we use the following exemplary embodiment curves:
E⁺: y²=x³+2x+1 over F₃l
E⁻: y²=x³+2x−1 over F₃l

Now, let <P> be a subgroup of E/Fₚl of prime order q with a security parameter α This parameter a must be large enough such that the Computational Diffie-Hellmann problem CDH is sufficiently difficult, but at the same time not so large as to render the computing of the Decision Diffie-Hellmann inefficiently difficult. Note that the security parameter of the two exemplary curves supra is α=6 (see Boneh). Furthermore, we assume the availability of a distortion map D or group isomorphism at our disposal so that the point D (P) ε E/Fₚl is linearly independent of the point P. The distortion map principle has been explicitly discussed in the publication by E. Verheul: “Evidence that XTR is more Secure than Supersingular Elliptic Curve Cryptosystems”, EUROCRYPT 2001. This distortion map then constitutes an efficiently computable isomorphism between the groups <P> and <D (P)>. Note that the elliptic curves of this example are only two among a large plurality thereof.

Now, with two linearly independent points P and D (P) we can use the Weil Pairing to solve certain problems. Now, let E [q] denote the subgroup of E/Fₚlα that is generated by P and D (P).In that case, the Weil Pairing is a map according to e: E [q]×E [q]→F*ₚl, and which satisfies the following properties:
1. For P ε E[q] we have e (P, P)=1.
2. For all P1, P2 ε E[q], and r, s ε Z, we have e (aP1, bP2)=e (P1, P2)^{ab}, the bilinearity property.
3. If for P ε E [q] one has that e (P, P′)=1 for all P′ ε E [q], then P=0: the non-degeneration property.
4. For all P1, P2 ε E [q], the Weil Pairing e ( P1, P2) can be computed efficiently: the computability property.

Then, the following scheme is set up. Each of two user facilities gets the following secret data items from a trusted third party, which items hereinafter being listed for user i (note that the trusted party may be one of the two cooperating user facilities):
5. (t₁₁+rᵢt₁₂)P
6. (t₁₂+rᵢt₂₂)P

Furthermore, the following two data items are provided as well:
7. rᵢD (P)
8. rᵢ²D (P)

However, the latter two data items need not necessarily be kept secret, and in consequence may for example be stored in a public directory for later consultation. Furthermore, the following symmetric matrix T (T₁₂=T₂₁) is defined:

$$T = ( \begin{matrix}{t}_{11} & {t}_{12} \\ {t}_{12} & {t}_{22}\end{matrix} ) ∈ {M}_{2} ( {Z}_{q} )$$

Furthermore, we introduce the vectors v (r) that are associated to a point r ε Z_{q} as follows: v (r)=(1 , r). Now, thereafter the protocol proceeds as follows:

First, User 1 sends data r₁D (P), r₁²D (P) to User 2, and furthermore, User 2 sends data r₂D (P), r₂²D (P) to User 1, followed by user 1 checking whether the triple r₂D (P), r₂D (P), r₂²D (P) is a Diffie-Hellmann triple, and user 2 checking whether the triple r₁D (P), r₁D (P), r₁²D (P) is a Diffie-Hellmann triple, and in the positive case both calculate the shared key by user 1 according to IIᵢ₌₁²e ((tᵢ₁+r₁tᵢ₂) P, v(r₂)ᵢD (P))=e (P, D (P))^{<v(r}_{¹}^{), Tv(r}_{²}^{)>}, the secret common key. Herein t₁₂=t₂₁and v(r₂) stands for the i-th component of the vector v(r₂). It can be proven that the security of the above protocol is high. The security in effect primarily resides on the finding that the Extended Diffie-Hellmann problem is difficult.

Additional measures to further raise the security level are a hashing of the generated shared key together with the applying of a time stamp. Furthermore, the generating protocol for generating a shared secret can be used as an initial step of an identification procedure as disclosed in EP Patent Application 02 075 983.3, attorney docket PHNL020192 and assigned to the same assignee as the present Application.

Furthermore, the protocol can be made more efficient by already computing the evaluation of the Weil Pairing e ((t₁₁+r₁t₁₂) P, D (P)) in advance. This will avoid the necessity to do the computation of this Weil Pairing at the execution of the protocol proper, although at a trading-off price of a raised storage requirement.

### DETAILED DESCRIPTION OF PREFERRED EMBODIMENTS

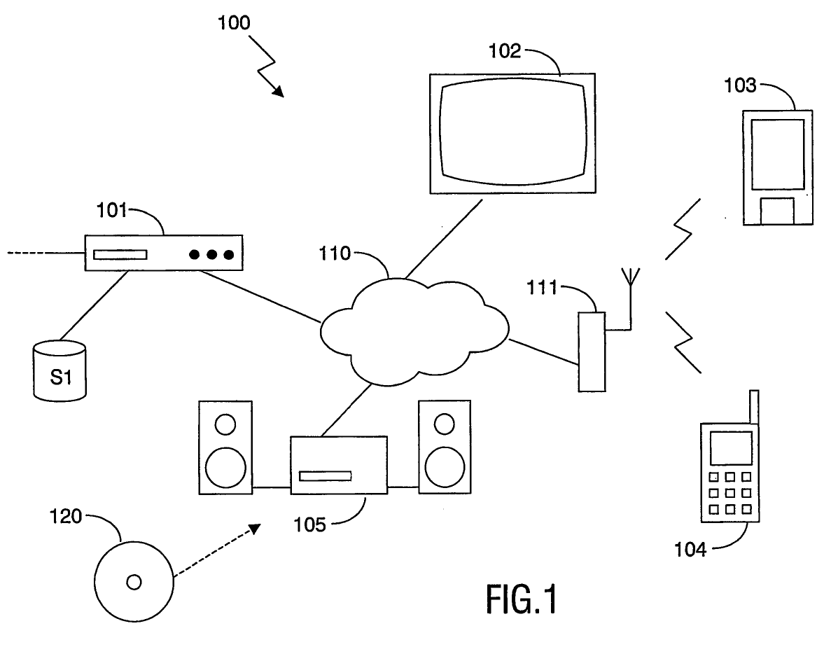

FIG. 1 illustrates a system 100 comprising various devices 101-105 that are interconnected via a network and are arranged to operate in accordance with the invention. By way of example, the system is an in-home system, that may comprise devices such as a radio receiver, a television set, etcetera. Generally, a particular device is the system master, and will control the others. Content is generally received through one or more of the devices, such as a residential gateway or settop box 101, from an external source, such as broadband, Internet or satellite. Eventually, the content is transferred over the network for appropriate rendering in one of the devices.

Typically, all devices in the in-home network will implement the security framework in accordance with the implementation requirements. Using this framework, these devices can authenticate each other and distribute content in a secure manner. Access to the content proper will be managed by the security system. This will prevent against unprotected content leaking away to unauthorized devices and also, against data originating from untrusted devices entering into the system. With such protection, devices may only distribute content to other devices which they have succesfully authenticated beforehand. This ensures that an adversary may not receive unauthorized copies through a malicious device. A particular device will only be able to succesfully authenticate itself if it was built by an authorized manufacturer, for example because only authorized manufacturers will know a particular secret that is necessary for succesful authentication, because their devices are provided with a certificate issued by a Trusted Third Party.

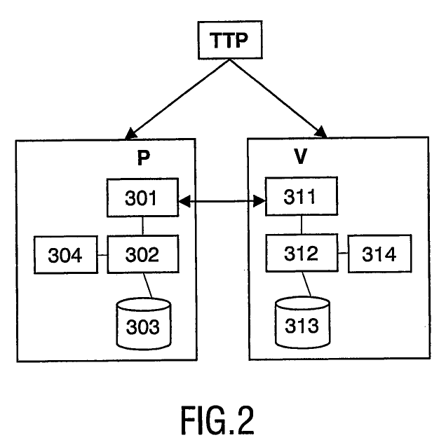

FIG. 2 illustrates a generalization of the system of FIG. 1. Here, a Prover P, a Verifier V, and a trusted third party TTP cooperate. Now, the Verifier V should want to authenticate the prover P through using information received from the Trusted Third Party TTP. Preferably, the authentication should be mutual, so that also the Prover P would know that the Verifier V were authentic.

The information necessary to authenticate the Verifier V to the Prover P is assumed to have been distributed beforehand from the TTP to the parties P and V. This can be done over a suitable communication facility between the three parties. This renders the protocol dynamic and allows updating of the information in case an adversary would manage to obtain unauthorized access to a secret distributed previously.

The prover P and verifier V can be devices such as carrier 120 in FIG. 1, that is equipped with a chip that provides the necessary functionality, and furthermore the audio playback device 105. In such case, there will most likely be no communication channel from the TTP to Prover P and Verifier V. Distribution of the secrets must then be effected beforehand, such as during manufacturing.

Now, the prover comprises a networking module 301, a cryptographic processor 302, and a storage medium 303. Using the networking module 301, Prover P can transmit and receive data with respect to the Verifier V. The networking module 301 could be connected to the network 110 in FIG. 1, or rather establish a direct connection such as wireless with the verifier V.

The cryptographic processor 302 is arranged to execute the method according to the present invention. Usually, this processor 302 will be realized as a combination of hardware and software, but alternatively it could be realized entirely in either one of these, such as by a collection of software modules or objects.

Now the Prover P may store in the storage medium various parameters of the algorithm to execute, but it may furthermore also hold some content to distribute to the Verifier V after succesful authentication. The storage medium 303 may furthermore be used to store the information received from the TTP. To enhance the security of the system, rather than storing the individual parameter data, one or more intermediate calculation results could be stored instead or additionally.

Similarly, the Verifier V comprises a networking module 311, a cryptographic processor 312, and a storage facility 313 with the functionality thereof corresponding to that of the Prover P. If the Verifier V is embodied as a carrier with a Chip-in-Disc, then the storage facility 313 may correspond to the storage available to any optical or other disc, but will preferably be stored in ROM of the Chip-in-Disc.

Additionally, the Prover P and the Verifier V may be provided with a pseudo-random number generator 304, 314 that is realized in hardware or software, and provides cryptographically strong pseudo-random numbers. These numbers are used in various preferred applications of the present invention.

### SUPPLEMENTARY MATHEMATICAL REPRESENTATION

Hereabove, the generation of the common secret key was effected according to:
Kᵢⱼ=F (Sᵢ, Pⱼ)==F (Sⱼ, Pᵢ) K_{ij.},
Whereas the following data were transferred:
Sᵢ=f_{T} (rᵢ) (5,6), and
Pᵢ=g (rᵢ) (7, 8)
Another representation of the transmitted data items is according to
Sᵢ sᵢ₁=T₁₁+rᵢT₁₂ (5′)
sᵢ₂=T₂₁+rᵢT₂₂ (6′)
Pᵢ Pᵢ₁=rᵢP (7′)
Pᵢ₂=rᵢ²P (8′)
Here, Tᵢⱼ=tᵢⱼ*P, and the numerals indicating the correspondence with the earlier representation.

1. A method for generating a common secret data item between a first user facility i and a second user facility j through by each such user facility executing mutually symmetric operations on respective complementary data items that are based on respectively unique quantities and that are at least in part secret, and wherein an outcome of said operations is used in both said user facilities as said common secret data item,
said method being characterized in being based on defining said complementary data belonging to a GAP Diffie-Hellmann Problem that is defined in an Abelian Variety.

2. A method as claimed in claim 1, wherein said Abelian Variety has a dimension one through being an elliptic curve.

3. A method as claimed in claim 1, comprising applying a pairing F featuring a bilinearity property, a non-degeneration property, and a computability property to two linearly independent points P and D (P) on said Abelian Variety.

4. A method as claimed in claim 1, wherein said operations for user facility i are based on one-way functions f, g according to Sᵢ=f_{T} (rᵢ) and Pᵢ=g (rᵢ), wherein parameter T is a master secret acquired from a trusted master facility, outcome S is being maintained secret, and common secret data are calculated according to
Kᵢⱼ=F (Sᵢ, Pⱼ)=F (Sⱼ, Pᵢ)=Kⱼᵢ.

5. A method as claimed in claim 4, wherein said operations base on data Sᵢ and Pᵢ
Sᵢ: sᵢ₁=T₁₁+rᵢT₁₂; (5′)
sᵢ₁=T₂₁+rᵢT₂₂; (6′)
Pᵢ: pᵢ₁=rᵢP; (7′)
pᵢ₂=rᵢ²P; (8′)

6. A method as claimed in claim 1, wherein user facility 1 sends data rᵢD (P), r₁²D (P) to user facility 2, user facility 2 sends data random r₂D (P), r₂²D (P) to user facility 1, followed by user facility 1 checking whether the triple r₂D (P), r₂D (P), r₂²D (P) is a Diffie-Hellmann triple, and user facility 2 whether the triple r₁D (P), r₁D (P), r₁²D (P) is a Diffie-Hellmann triple, and in the positive case calculating the common secret by user facility 1 according to IIₖ₌₁²e ((tₖ₁+r₁tₖ₂) P, v (r₂)ₖD (P))=e (P, D (P))^{<v(r}_{¹}^{), Tv(r}_{²}^{)>} wherein t₁₂=t₂₁and v(r₂)ₖ stands for the k-th component of the vector v(r₂).

7. A method as claimed in claim 1, and furthermore comprising a revocation scheme on top of its standard scheme for excluding one or more selected user facilities through assigning to every user facility its own unique parameters.

8. A method as claimed in claim 1, wherein the generating of such shared secret is used as an initial step in an identification or authentication procedure.

9. A method as claimed in claim 1, wherein the Weil Pairing is evaluated at an instant in time that lies substantially before executing the protocol proper.

10. A method as claimed in claim 1, and comprising an updating of secret information against divulgation of an earlier secret information.

11. A method as claimed in claim 1, and being executed through using only a single integrated cryptography level.

12. A method as claimed in claim 1, where a randomization scheme is applied to the common secret.

13. A method as claimed in claim 12, where the randomization scheme is based on a challenge-response mechanism.

14. A system comprising a first user facility and a second user facility, and being arranged to communicate according to the method as claimed in claim 1.

15. A device being arranged to operate as the first and/or second user facility in a system as claimed in claim 14.

16. A computer program product comprising instructions for controlling one or more data processing oriented hardware entities to implement a method as claimed in claim 1.
